(19) United States
(12) Patent Application Publication
(10) Pub. No.: US 2024/0071739 A1
(43) Pub. Date: Feb. 29, 2024

(54) GEOMETRIES FOR RADIO-FREQUENCY MULTIPOLE ION GUIDES

(71) Applicant: Thermo Finnigan LLC, San Jose, CA (US)

(72) Inventors: Hoa PHAM, San Jose, CA (US); Philip REMES, Livermore, CA (US)

(21) Appl. No.: 18/455,061

(22) Filed: Aug. 24, 2023

Related U.S. Application Data
(60) Provisional application No. 63/373,403, filed on Aug. 24, 2022.

(51) Int. Cl. H01J 49/06

(52) U.S. Cl. CPC H01J 49/063

(57) ABSTRACT

An embodiment of the present invention provides an RF ion guide having four elongated electrodes arranged in parallel around the axial centerline. Each electrode is generally L-shaped in cross section, having first and second inner surfaces directed toward the interior of the ion guide. The first and second surfaces extend along axis that are transverse and preferably approximately perpendicular to one another. RF voltages of equal amplitude but opposite phases are applied to opposed pairs of electrodes, in the manner known in the art, to generate an RF field to radially confine ions and focus them to the centerline. Because the resultant RF field more closely approximates a quadrupolar field, relative to the field generated within a flatapole, better performance may be achieved in terms of improved transmission efficiencies and/or less mass discrimination.

### BACKGROUND OF THE INVENTION

### Field of the Invention

The invention relates generally to mass spectrometry, and more particularly to designs for radio-frequency (RF) multipole ion guides for transporting and focusing ions in the vacuum regions of a mass spectrometer.

### Description of Related Art

RF multipole ion guides are well-known devices used in mass spectrometers (as well as in other instruments) for delivering ions from a source through a set of vacuum regions to a mass analyzer. The multipole ion guides typically consist of a plurality of elongated electrodes (usually four, but sometimes six or eight) arranged in parallel around an axial centerline along which ions travel between an entrance and an exit of the ion guide. RF voltages are applied to the electrodes in a prescribed phase relationship to create an electrical field that focuses the ions toward the axial centerline. For example, in a quadrupole ion guide having four elongated electrodes, a first RF voltage is applied to one pair of electrodes (the pair comprising two electrodes opposed across the centerline), and a second RF voltage, of equal amplitude to the first but an opposite phase is applied to the other electrode pair, generating a substantially quadrupolar pseudopotential that radially confines and focuses the ions. This field may be superimposed with a direct current (DC) axial field, generated, for example, by application of DC voltages to auxiliary electrodes, to urge the ions along the axial direction of travel.

Various cross-sectional shapes have been used for the elongated electrodes (sometimes referred to as rod electrodes or RF electrodes). Most commonly, cylindrical electrodes having a continuous circular cross-section have been utilized, but elongated electrodes having square, rectangular and even elliptical cross-sections have been described in the prior art and/or implemented in commercial instruments. Recently, a number of RF ion guides have been developed that leverage printed circuit board technology, in particular for applications where the ion guide operates in relatively high pressure (e.g., 1-10 mTorr) regions of the mass spectrometer. One such design, used in mass spectrometers manufactured and sold by Thermo Fisher Scientific, employs two opposed circuit boards having flat-inlaid electrodes. This design is sometimes referred to colloquially as a “flatapole.” Advantages of this design include the relatively low cost of fabrication and assembly, as well as the ability to easily fabricate ion guides having a curved or otherwise non-linear axial centerline.

One drawback of the above-described flatapole ion guide is that the RF pseudo potential generated within the ion guide is significantly weaker relative to traditional (e.g., round-rod) designs. This may result in poorer transmission efficiencies and greater mass discrimination, particularly for curved ion guides. Against this background, there is a need in the art for an ion guide design that provides better transmission efficiency across the mass range of interest, while preferably still being compatible with circuit board technology.

### SUMMARY OF THE INVENTION

Roughly described, an embodiment of the present invention provides an RF ion guide having four elongated electrodes arranged in parallel around the axial centerline. Each electrode is generally L-shaped in cross section, having first and second inner surfaces directed toward the interior of the ion guide. The first and second surfaces extend along axis that are transverse and preferably approximately perpendicular to one another. RF voltages of equal amplitude but opposite phases are applied to opposed pairs of electrodes, in the manner known in the art, to generate an RF field to radially confine ions and focus them to the centerline. Because the resultant RF field more closely approximates a quadrupolar field, relative to the field generated within a flatapole, better performance may be achieved in terms of improved transmission efficiencies and/or less mass discrimination.

In more specific implementations, the ion guide may be straight or curved. A set of longitudinally segmented DC electrodes may be arranged in parallel to the elongated electrodes and coupled to a DC voltage source for establishing a DC field gradient within the ion guide interior that urges ions along the direction of travel. One or more of the DC electrodes may be situated in or proximate to a gap between adjacent elongated electrodes.

### BRIEF DESCRIPTION OF THE DRAWINGS

In the accompanying drawings:

FIG. 1 is a symbolic cross-sectional diagram of an RF quadrupole ion guide, constructed in accordance with one embodiment of the invention; and

FIG. 2 is a variant of the FIG. 1 ion guide, with the L-shaped electrodes replaced with electrodes having an angled inner surface.

### DETAILED DESCRIPTION

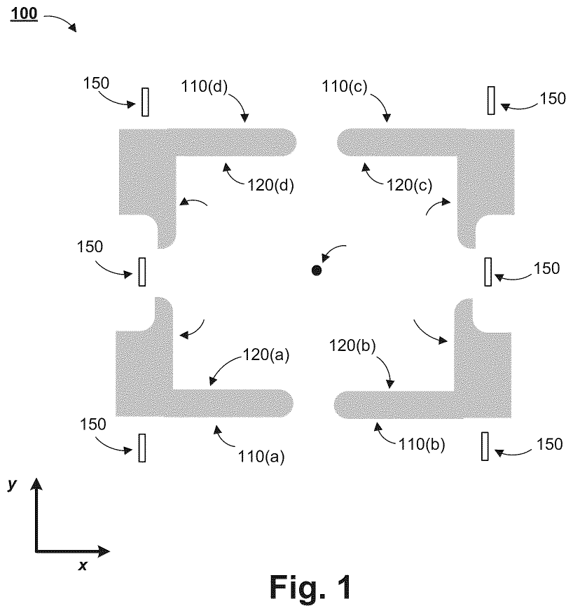

FIG. 1 depicts in cross-sectional view the arrangement and geometry of an RF multipole ion guide 100 constructed in accordance with an embodiment of the invention. Ion guide 100 includes four elongated electrodes 110a-d arranged about an axial centerline 140. Electrodes 110a-d extend longitudinally in the z-dimension normal to the plane of the drawing, preferably with a substantially invariant cross-section. Electrodes 110a-d are arranged parallel to one another and to axial centerline 140. Axial centerline 140 corresponds to the overall direction of ion travel, and may be either straight, defining a straight ion guide, or curved, defining a curved ion guide. In one example, the ion guide may describe a ninety-degree turn. Curved ion guides are known to be effective in separating ions from background neutrals (which are pumped out of the vacuum chamber in which ion guide 100 is situated). Electrodes 110a-d may be fabricated wholly from a conductive material (e.g., a metal), or may be constructed from a non-conductive material to which a conductive coating is applied.

As depicted in FIG. 1, each electrode is generally L-shaped, and has first and second inner surfaces directed toward the interior region of ion guide 100. More specifically, electrodes 110a-d have respective first inner surfaces 120a-d and second inner surfaces 130a-d. The first and second inner surfaces of each electrode are oriented transversely and preferably approximately perpendicularly to one another. For example, electrode 110a has first surface 120a oriented approximately perpendicularly to second surface 130a; electrode 110b has first surface 120b oriented substantially perpendicularly to second surface 130b, and so on. Electrodes 110a-d are preferably arranged in symmetrical relationship such that they define the corners of a square or rectangular ion guide interior region. In FIG. 1, corresponding surfaces of adjacent electrodes are shown to generally align with one another, e.g., first surfaces 120a and 120b of electrodes 110a and 110b align with one another along the x-axis, and second surfaces 130a and 130d of electrodes 110a and 110d align with each other along the y-axis. Adjacent electrodes are electrically insulated from each other by means of gaps (either air gaps, or gaps filled with a non-conductive material) separating them. The exact dimensions and spacing of electrodes 110a-d may be selected to optimize ion transmission efficiencies and in view of other operational considerations (including avoidance of electrical arcing, effect on pumping efficiency, and DC field penetration, as will be described in more detail below).

A not-depicted RF voltage source may be employed to apply RF voltages to electrodes 110a-d to generate the radially confining RF electric field. Typically the RF voltage source would be arranged to apply a first RF voltage to one opposed pair of electrodes (e.g., electrodes 120a and 120c), and to apply a second RF voltage of equal amplitude but 180° out of phase to the second electrode pair (electrodes 120b and 120d). The amplitude and frequency of the applied RF voltages may be set in view of various considerations, including the cost and capability of the RF power supply, the size and spacing of electrodes 110a-d, the operating conditions (e.g., gas pressure) within the vacuum chamber in which ion guide 100 is placed, the required field strength to efficiently transport ions, and the need to avoid excessive undesired fragmentation of analyte ions.

Modeling of the RF field generated within ion guide 100 show that the field more closely approximates the ideal quadrupolar field relative to the field within flatapoles. This strengthens the restoring force of the pseudo-potential, promoting better radial confinement of ions and reduced ion loss, thereby increasing transmission efficiencies. The RF field within ion guide 100 also exhibits favorable performance metrics, including a wide single mass stability ratio, which facilitates transmission of low m/z ions, as well as a low simultaneous mass ratio, which improves transmission of ions having a wide range of m/z's. Ion guide 100 may be beneficially employed in different regions of a mass spectrometer or similar instrument, but may be particularly advantageous in the relatively high-pressure chambers, where gas pressures are more than 1 mTorr, more than 10 mTorr, or more than 100 mTorr.

In certain embodiments, a DC gradient may be established along the axial centerline of ion guide 100 to urge ions moving from the entrance to the exit and prevent ion “stalling”, which may occur in regions of relatively high pressure. Various means are known in the prior art for establishing a DC gradient within an ion guide. In the present example depicted in FIG. 1, a set of DC electrodes 150 are positioned proximate to elongated electrodes 110a-d and are segmented along the longitudinal axis. These DC electrodes may be formed, for example, via deposition on a circuit board substrate. DC electrodes 150 may be longitudinally co-extensive with elongated electrodes 110a-d or may only extend along a portion thereof. A not depicted DC voltage source applies the DC voltages to DC electrodes 150 through a not-depicted resistor network, such that the magnitude of the voltages increase or decrease in the direction of ion travel, depending on the sign of the desired DC gradient (which in turn depends on the polarity of the ions traveling through ion guide 100). The application of the DC voltages to DC electrodes 150 in the manner described generates an axial DC field within the interior of ion guide 100. Penetration of the DC field may be facilitated by placing at least some of DC electrodes 150 within or proximate to gaps between adjacent elongated electrodes, for example in the gap between elongated electrodes 110a and 110d and between elongated electrodes 110b and 110c.

It is noted that implementations of the invention may utilize the circuit board-based design employed in the flatapole ion guide, with the elongated electrodes deposited on or affixed to an underlying circuit board substrate.

While elongated electrodes 110a-d are preferably fabricated as being longitudinally continuous from the entrance to the exit of ion guide 100, in certain embodiments they may be longitudinally segmented, with adjacent segments being electrically insulated from one another. This would allow for the establishment of a DC gradient by applying differential DC voltages to the segmented of the elongated electrodes (not that all segments of an elongated electrode would also receive an RF voltage), eliminating the need for separate DC electrodes.

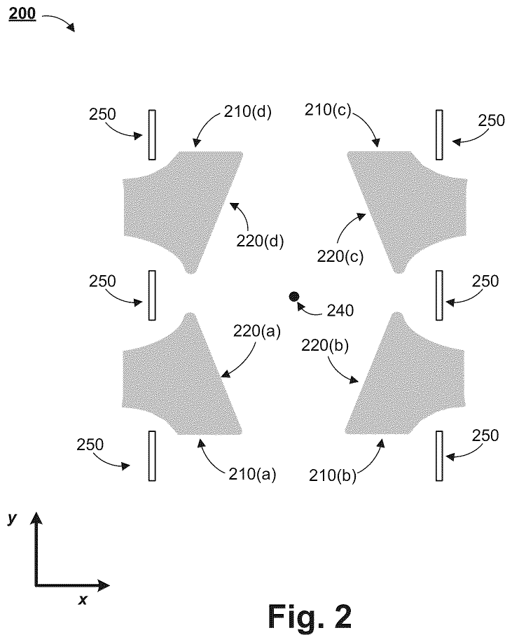

FIG. 2 depicts a variant of the ion guide design of FIG. 1. As depicted, an ion guide 200, shown in cross-sectional view, includes a set of four elongated electrodes 210a-d arranged around an axial centerline 240. Each elongated electrode 210a-d has a corresponding inner surface 220a-d directed toward the interior region of ion guide 200. Inner surfaces 220a-220d are all angled toward axial centerline 240, in contradistinction to the flatapole electrode design, in which the inner surfaces of the electrodes are oriented parallel to the y-axis. The angles defined by inner surfaces 220a-d may be optimized in view of desired manufacturing and performance characteristics. RF voltages are applied to opposed electrode pairs in the manner described above in connection with FIG. 1. A DC gradient may also be generated by application of DC voltages to segmented DC electrodes 250, again in much the same manner as described above.

Modeling of the FIG. 2 ion guide has indicated that it produces an RF field that is closer to the ideal quadrupolar field relative to the flatapole design, but is inferior to the RF field associated with the FIG. 1 embodiment. Similarly, improvements in performance relative to the flatapole may be expected, but such performance gains are less than what is achieved using the FIG. 1 design.

What is claimed is:

1. A radio-frequency (RF) multipole ion guide, comprising:
at least four elongated electrodes arranged in parallel around an axial centerline, each electrode being generally L-shaped in cross-section and having first and second inner surfaces directed toward an interior of the ion guide, the first and second surfaces being oriented transversely to one another; and
an RF voltage source for supplying RF voltages to the elongated electrodes in a predetermined phase relationship.

2. The RF multipole ion guide of claim 1, wherein the first and second surfaces are oriented approximately perpendicularly to one another.

3. The RF multipole ion guide of claim 1, further comprising sets of segmented DC electrodes positioned proximate the elongated electrodes, and a DC voltage source coupled to the electrodes for applying DC voltages to the DC electrodes to generate a DC gradient along the axial centerline.

4. The RF multipole ion guide of claim 1, wherein at least one set of surfaces of adjacent elongated electrodes are aligned with one another.

5. The RF multipole ion guide of claim 1, wherein adjacent elongated electrodes are electrically insulated from each other by means of gaps separating them.

6. The RF multipole ion guide of claim 1, wherein the dimensions and spacing of the at least four elongated electrodes are selected to optimize ion transmission efficiencies in view of effect on pumping efficiency.

7. The RF multipole ion guide of claim 1, wherein the ion guide is employed in a chamber of a mass spectrometer having gas pressures are more than 10 mTorr.

8. The RF multipole ion guide of claim 1, wherein the ion guide is employed in a chamber of a mass spectrometer having gas pressures are more than 100 mTorr.

9. The RF multipole ion guide of claim 1, wherein the ion guide is configured to establish a DC gradient along the axial centerline of ion guide to urge ions moving from the entrance to the exit and prevent ion stalling in regions of relatively high pressure.
